(19) United States
(12) Patent Application Publication
(10) Pub. No.: US 2025/0251348 A1
(43) Pub. Date: Aug. 7, 2025

(54) SYSTEM, METHOD, AND APPARATUS FOR DETECTING FOLDING FAULT OF SECONDARY BATTERY

(71) Applicant: SK ON CO., LTD., Seoul (KR)

(72) Inventors: Yu Ri SONG, Daejeon (KR); Do Young KIM, Daejeon (KR); Ung Bae PARK, Daejeon (KR); Byoung Hak LEE, Daejeon (KR); Jung Taek LIM, Daejeon (KR); Byung Wook JANG, Daejeon (KR); Young Jin JANG, Daejeon (KR)

(21) Appl. No.: 19/025,095

(22) Filed: Jan. 16, 2025

(30) Foreign Application Priority Data
Feb. 6, 2024 (KR) 10-2024-0018237

(51) Int. Cl. G01N 21/892; G01B 11/06; H01M 10/42; H01M 50/105

(52) U.S. Cl. CPC G01N 21/892; G01B 11/0608; G01B 11/0691; H01M 10/4285; H01M 50/105

(57) ABSTRACT

The present disclosure provides a system, method and apparatus for detecting a folding fault in a secondary battery. A method according to an embodiment of the present disclosure may include: measuring a height of a folding part and a height of a pouch case of the secondary battery being transferred by a transfer apparatus for each designated section using a laser scanner; checking whether there is a section where the height of the folding part is greater than the height of the pouch case, provided that a height difference therebetween is a designated reference value or more; and if there is a section where the height difference is the designated reference value or more, determining that the folding fault has occurred.

### CROSS-REFERENCE TO RELATED APPLICATION AND CLAIM OF PRIORITY

This application claims priority to Korean Patent Application No. 10-2024-0018237 filed on Feb. 6, 2024 in the Korean Intellectual Property Office (KIPO), the entire disclosure of which is incorporated by reference herein.

### BACKGROUND OF THE INVENTION

### 1. Field of the Invention

The present disclosure relates to a system, method and apparatus for detecting folding fault of a secondary battery.

### 2. Description of the Related Art

A secondary battery is a battery that can be repeatedly charged and discharged. With rapid progress of information and communication, and display industries, the secondary battery has been widely applied to various portable electronic telecommunication devices such as a camcorder, a mobile phone, a tablet personal computer (PC), a laptop PC, etc. as a power source thereof. Recently, a battery pack including the secondary battery has also been developed as a power source of an eco-friendly automobile such as an electric vehicle.

Meanwhile, when manufacturing the secondary battery, various faults may occur. For example, in the case of a pouch-type secondary battery, when a folding part formed by folding a part (e.g., a portion which is sealed for sealing a pouch cell) of the pouch cell (or a pouch case) protrudes from the surface of the pouch cell, faults may occur during assembly of the secondary battery (e.g., assembly of a module). In order to prevent faults from occurring during assembly, an optical system is currently used to inspect whether a folding fault in which the folding part protrudes from the surface of the pouch cell has occurred after manufacturing the secondary battery. For example, the folding part and outer peripheries of the pouch cell are photographed through a camera, and the photography images are analyzed to inspect whether there is a folding fault.

However, the optical system has a problem in that it is difficult to recognize (e.g., measure) heights of the pouch cell and the folding part based on the images captured by the camera due to the shadow caused by curvatures existing in the outer peripheries of the pouch cell and the folding part.

### SUMMARY OF THE INVENTION

An object of the present disclosure is to provide a system, method and apparatus for detecting a folding fault of a secondary battery, which may improve accuracy of folding fault detection.

Another object of the present disclosure is to provide a system, method and apparatus for detecting a folding fault of a secondary battery, which may improve stability of folding fault detection.

To achieve the above objects, according to an aspect of the present invention, there is provided a method for detecting a folding fault of a secondary battery, which includes: measuring a height of a folding part and a height of a pouch case of the secondary battery being transferred by a transfer apparatus for each designated section using a laser scanner, checking whether there is a section where the height of the folding part is greater than the height of the pouch case, provided that a height difference therebetween is a designated reference value or more; and if there is a section where the height difference is the designated reference value or more, determining that the folding fault has occurred.

According to an embodiment, the laser scanner may be fixedly disposed on an upper side of the rail of the transfer apparatus. The measuring step may be performed while the carrier on which the secondary battery is placed moves to pass a lower end of the laser scanner along the rail at a designated speed.

According to an embodiment, a partial region of a measurement range of the laser scanner may be set as a region of interest. The measuring step may include measuring the height of the pouch case through a first region of interest among the regions of interest, and measuring the height of the folding part through a second region of interest among the regions of interest.

According to an embodiment, the measuring step may include starting the measurement when the secondary battery is detected in the region of interest, and ending the measurement when the secondary battery is not detected from the region of interest.

According to an embodiment, the measuring step may include measuring the height of the folding part and the height of the pouch case for each designated section in a longitudinal direction of the secondary battery.

According to an embodiment, the measuring step may include determining a maximum value among the heights of the folding part measured in each section as the height of the folding part in the corresponding section, and determining a maximum value among the heights of the pouch case measured in each section as the height of the pouch case in the corresponding section.

According to an embodiment, the method may further include outputting the determined heights of the folding part and the determined heights of the pouch case by illustrating them as a graph.

According to an embodiment, the method may further include generating an alarm in a designated manner when it is determined that the folding fault has occurred.

In addition, according to another aspect of the present invention, there is provided an apparatus for detecting a folding fault of a secondary battery, which includes: a laser scanner configured to emit a laser in a designated range according to a designated scan rate and receive a reflected laser; and a processor configured to control the laser scanner to measure a height of a folding part and a height of a pouch case of the secondary battery being transferred by a transfer apparatus for each designated section, check whether there is a section where the height of the folding part measured through the laser scanner is greater than the height of the pouch case, provided that a height difference therebetween is a designated reference value or more, and if there is section where the height difference is the designated reference value or more, determine that the folding fault has occurred.

According to an embodiment, the laser scanner may be fixedly disposed on an upper side of the rail of the transfer apparatus. The processor may measure the height of the folding part and the height of the pouch case while the carrier on which the secondary battery is placed moves to pass a lower end of the laser scanner along the rail at a designated speed.

According to an embodiment, a partial region of a measurement range of the laser scanner may be set as a region of interest. The processor may measure the height of the pouch case through a first region of interest among the regions of interest, and measuring the height of the folding part through a second region of interest among the regions of interest.

According to an embodiment, the processor may start the measurement when the secondary battery is detected in the region of interest, and end the measurement when the secondary battery is not detected from the region of interest.

According to an embodiment, the processor may measure the height of the folding part and the height of the pouch case for each designated section in a longitudinal direction of the secondary battery.

According to an embodiment, the processor may determine a maximum value among the heights of the folding part measured in each section as the height of the folding part in the corresponding section, and determine a maximum value among the heights of the pouch case measured in each section as the height of the pouch case in the corresponding section.

According to an embodiment, the apparatus may further include a display configured to output the determined heights of the folding part and the determined heights of the pouch case by illustrating them as a graph.

According to an embodiment, the apparatus may further include an alarm module configured to generate an alarm in a designated manner when the folding fault occurs.

Further, according to another aspect of the present invention, there is provided a system for detecting a folding fault of a secondary battery, which includes: a transfer apparatus configured to transfer the secondary battery; a laser scanner fixedly installed on one side of the transfer apparatus, and configured to measure a height of a folding part and a height of a pouch case of the secondary battery while being transferred through the transfer apparatus for each designated section; and a detection apparatus configured to detect whether a folding fault occurs based on the height of the folding part and the height of the pouch case measured by the laser scanner.

According to an embodiment, the present disclosure may improve the accuracy of folding fault detection. For example, the present disclosure may accurately detect whether there is a folding fault by measuring the height of the folding part and the height of the pouch case using a laser scanner with fewer restrictions on the measurement environment (e.g., shade).

In addition, the present disclosure may improve the stability of folding fault detection. For example, the present disclosure may stably detect whether there is a folding fault by stably moving the secondary battery through a transfer apparatus while the laser scanner is fixed, and measuring the height of the folding part and the height of the pouch case.

### BRIEF DESCRIPTION OF THE DRAWINGS

The above and other objects, features and other advantages of the present invention will be more clearly understood from the following detailed description taken in conjunction with the accompanying drawings, in which:

FIGS. 1A and 1B are schematic views of a system for detecting a folding fault of a secondary battery according to an embodiment of the present disclosure;

FIG. 2 is a view for describing a method for measuring heights of a folding part and a pouch case of a secondary battery using a laser scanner according to an embodiment of the present disclosure;

FIG. 3 is a view for describing the method for measuring the heights of the folding part and the pouch case of the secondary battery using the laser scanner according to an embodiment of the present disclosure;

FIG. 4 is a view for describing an example of setting a section for measuring the height of folding part and the height of the pouch case of the secondary battery according to an embodiment of the present disclosure;

FIG. 5 is a graph illustrating the height of the folding part and the height of the pouch case when the folding fault does not occur according to an embodiment of the present disclosure;

FIG. 6 is a graph showing the height of the folding part and the height of the pouch case when the folding fault occurs according to an embodiment of the present disclosure;

FIG. 7 is a block diagram illustrating a configuration of an apparatus for detecting a folding fault of a secondary battery according to an embodiment of the present disclosure; and

FIG. 8 is a flowchart for describing procedures of a method for detecting a folding fault of a secondary battery according to an embodiment of the present disclosure.

### DETAILED DESCRIPTION OF THE INVENTION

Hereinafter, the present disclosure will be described in detail through embodiments with reference to the accompanying drawings. However, the embodiments are merely illustrative and the present disclosure is not limited to the specific embodiments described by way of example.

Although a first, a second, and the like are used to describe various elements, components and/or sections, these elements, components and/or sections are of course not limited by these terms. These terms are merely used to distinguish one element, component and/or section from another element, component and/or section. Therefore, it goes without saying that the first element, first component or first section mentioned below may also be the second element, second component or second section within the technical spirit of the present disclosure.

Terms used herein are for the purpose of describing particular embodiments only and are not intended to limit the present disclosure thereto. As used herein, singular forms are intended to include the plural forms as well, unless the context clearly indicates otherwise. It will be further understood that the terms “comprises” and/or “made of,” as used herein, do not preclude the presence or addition of one or more components, steps, operations and/or elements other than those mentioned component, step, operation and/or element.

Unless otherwise defined, all terms (including technical and scientific terms) used herein have the same meaning as commonly understood by one of ordinary skill in the art to which the present disclosure pertains. Terms, such as those defined in commonly used dictionaries, are not to be construed in an idealized or overly formal sense unless expressly so defined herein.

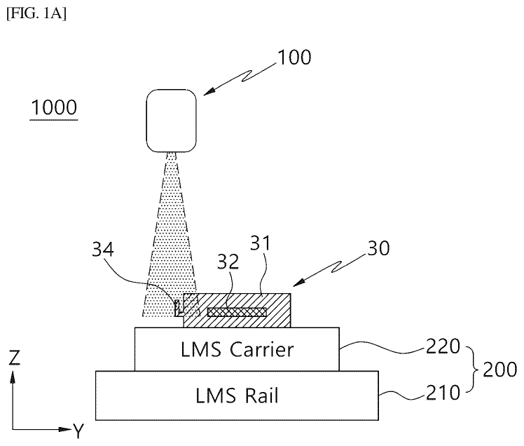

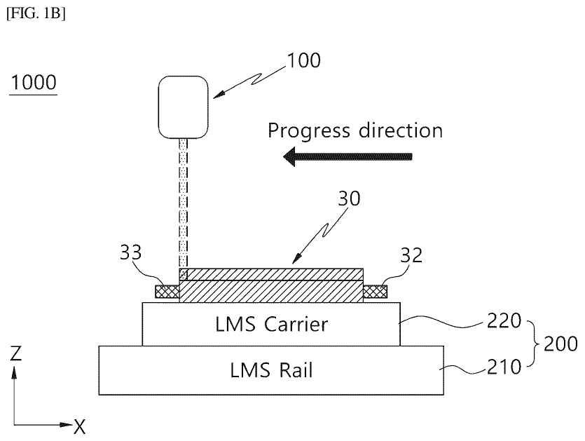

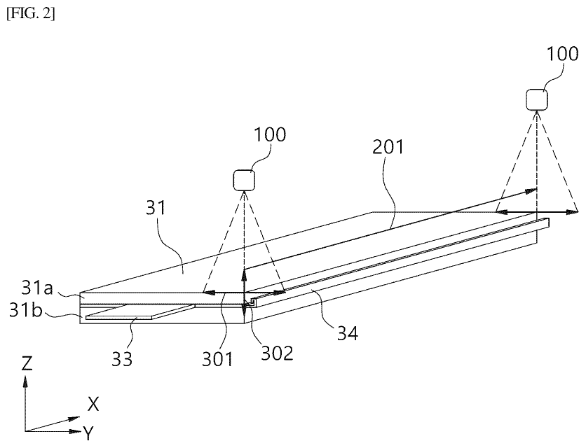

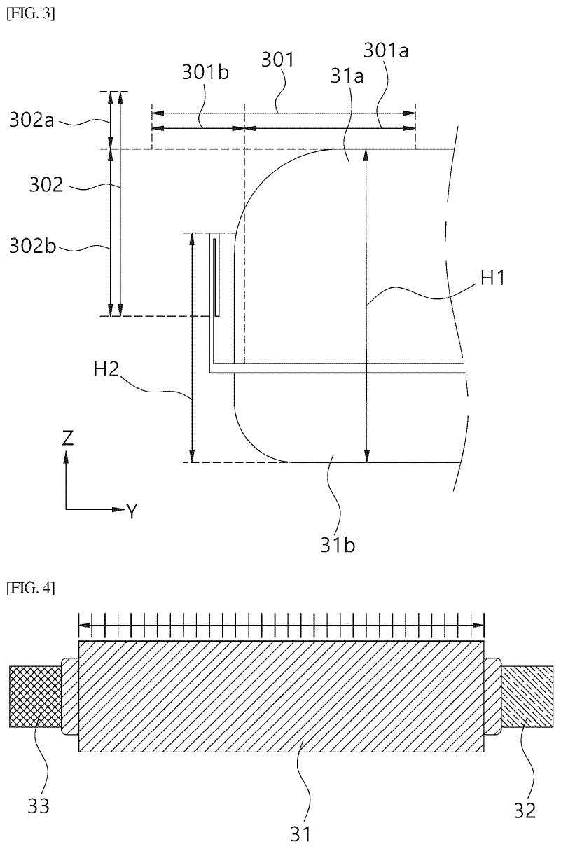

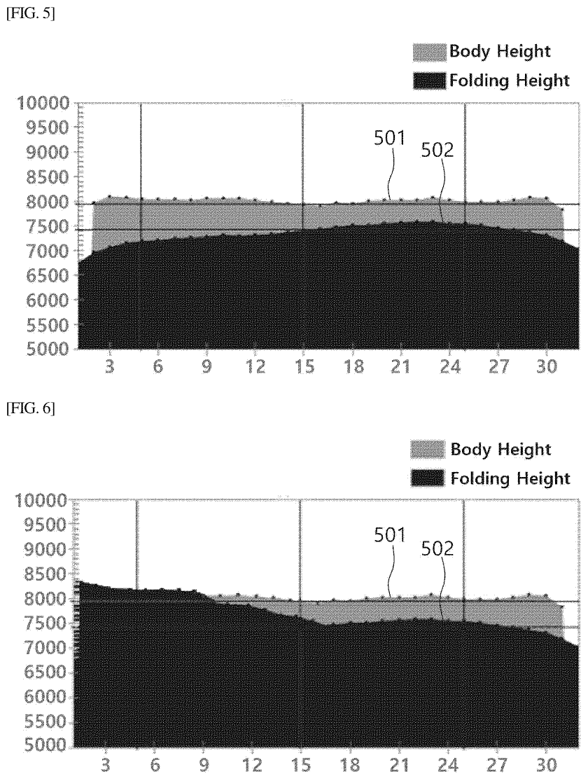

FIGS. 1A and 1B are schematic views of a system for detecting a folding fault of a secondary battery according to an embodiment of the present disclosure, FIG. 2 is a view for describing a method for measuring heights of a folding part and a pouch case of a secondary battery using a laser scanner according to an embodiment of the present disclosure, FIG. 3 is a view for describing the method for measuring the heights of the folding part and the pouch case of the secondary battery using the laser scanner according to an embodiment of the present disclosure, FIG. 4 is a view for describing an example of setting a section for measuring the height of folding part and the height of the pouch case of the secondary battery according to an embodiment of the present disclosure, FIG. 5 is a graph illustrating the height of the folding part and the height of the pouch case when the folding fault does not occur according to an embodiment of the present disclosure, and FIG. 6 is a graph showing the height of the folding part and the height of the pouch case when the folding fault occurs according to an embodiment of the present disclosure.

Prior to the detailed description of the present disclosure, the structure of a pouch-type secondary battery 30 will be briefly described. The secondary battery 30 may include a pouch case 31, a cathode tab 32, an anode tab 33, and a folding part 34. The pouch case 31 is a case forming an exterior of the secondary battery 30, and may include (e.g., house) an electrode assembly (not shown) composed of a cathode, a separator, and an anode. For example, the pouch case 31 may include a space (e.g., a main chamber) in which the electrode assembly is housed. The cathode tab 32 is connected to the cathode of the electrode assembly, and a portion thereof may be exposed to an outside of the pouch case 31. The anode tab 33 is connected to the anode of the electrode assembly, and a portion thereof may be exposed to the outside of the pouch case 31. The folding part 34 may be formed by folding a wing portion (e.g., a portion where an upper case 31a and a lower case 31b are bonded) of the pouch case 31 at least once. Meanwhile, the pouch case 31 may be called a pouch cell, a pouch film, a cell case, etc.

Referring to FIGS. 1A to 6, a system 1000 for detecting a folding fault of the secondary battery 30 (briefly, an inspection (or detection) system) according to an embodiment of the present disclosure may include a detection apparatus 100 and a transfer apparatus 200.

The transfer apparatus 200 may transfer the secondary battery 30. For example, the transfer apparatus 200 may control transfer of the secondary battery being manufactured according to a process procedure for manufacturing the secondary battery 30. In addition, the transfer apparatus 200 may control transfer of the secondary battery 30 (e.g., transfer the secondary battery 30 to a lower portion of the detection apparatus 100) for inspection of the secondary battery 30 (e.g., inspection of a folding fault). The transfer apparatus 200 may include a linear motion system (LMS). The transfer apparatus 200 may include a rail 210 forming a movement path, and a carrier 220 which an upper surface on which the secondary battery 30 is placed, and moves along the rail 210.

The detection apparatus 100 may detect a fault in the secondary battery 30. For example, the detection apparatus 100 may measure a height H1 of the pouch case 31 and a height H2 of the folding part 34 of the secondary battery 30, which are placed on the carrier 220 and transferred, using a laser scanner positioned on an upper side of the rail 210, and may detect whether there is a folding fault of the secondary battery 30 based on the measured heights H1 and H2. When the height H2 of the folding part 34 is greater than the height H1 of the pouch case 31, provided that a height difference therebetween is a designated reference value or more (e.g., a value of “0” or more), the detection apparatus 100 may determine that there is a folding fault. If it is determined that there is a folding fault, the detection apparatus 100 may generate an alarm in a designated manner. As the detection apparatus 100 measures the height H1 of the pouch case 31 and the height H2 of the folding part 34 using a laser scanner which has no restrictions on the measurement environment (e.g., shade) and is capable of measuring the height in a micrometer unit, it is possible to accurately detect (e.g., with improved accuracy) whether there is a folding fault.

According to an embodiment, the detection apparatus 100 may continuously or discretely measure the heights of the pouch case 31 and the folding part 34 in a longitudinal direction (e.g., an X-axis direction) of the secondary battery 30. To this end, the laser scanner of the detection apparatus 100 may be fixedly disposed on the upper side of the rail 210 of the transfer apparatus 200. In this case, the transfer apparatus 200 may move the carrier 220 on which the secondary battery 30 is placed along the rail 210 at a designated speed to pass a lower end of the laser scanner, as shown in FIG. 1b. Meanwhile, FIG. 2 illustrates as the laser scanner of the detection apparatus 100 is moved in a direction indicated by an arrow 201, but this is only to describe that the heights of the pouch case 31 and the folding part 34 are measured in the longitudinal direction of the secondary battery 30. In reality, the laser scanner is fixed to the upper side of the rail 210, and the secondary battery 30 is transferred in a direction opposite to the arrow 201 by the carrier 220. As the detection apparatus 100 stably moves the secondary battery 30 through the transfer apparatus 200 while the laser scanner is fixed, and measures the height H1 of the pouch case 31 and the height H2 of the folding part 34, it is possible to stably detect a folding fault (e.g., with improved stability).

The detection apparatus 100 may start measuring the heights of the pouch case 31 and the folding part 34 at a point in time when the secondary battery 30 is detected in a designated partial region (hereinafter, “a region of interest”) of a measurement range of the laser scanner, and end the measurement of the heights of the pouch case 31 and the folding part 34 when the secondary battery 30 is not detected in the region of interest (or when the secondary battery 30 is not detected for a designated period of time or more). Here, as shown in FIGS. 2 and 3, the region of interest may be set to have a designated width (e.g., in a Y-axis direction) 301 based on a boundary between the pouch case 31 and the folding part 34, and to have a designated depth (e.g., in a Z-axis direction) 302 based on an upper surface of the pouch case 31. The width 301 may include a first width 301a and a second width 301b. The first width 301a and the second width 301b may have the same or different sizes. The depth 302 may include a first depth 302a and a second depth 302b. The first depth 302a and the second depth 302b may have the same or different sizes. Here, the first width 301a and the depth 302 may be a first region of interest for measuring the height H1 of the pouch case 31, and the second width 301b and the depth 302 may be a second region of interest for measuring the height H2 of the folding part 34.

The detection apparatus 100 may measure the height H1 of the pouch case 31 and the height H2 of the folding part 34 for each designated section in the longitudinal direction of the secondary battery 30. For example, as shown in FIG. 4, the detection apparatus 100 may divide a length of the secondary battery 30 (e.g., a length of the pouch case 31) into the designated number (e.g., 32) of sections, and measure the height H1 of the pouch case 31 and the height H2 of the folding part 34 for each section. The designated number may be determined in consideration of a scan rate of the laser scanner, a moving speed of the carrier 220, and the length of the secondary battery 30.

Meanwhile, the height of the pouch case 31 and the height of the folding part 34 may be measured multiple times in each section. For example, when the scan rate of the laser scanner is fast or the moving speed of the carrier 220 is slow compared to a size (e.g., the length) of each interval, the height of the pouch case 31 and the height of the folding part 34 may be measured multiple times in each section. In this case, the detection apparatus 100 may determine a maximum value among the heights of the pouch case 31 measured in each section as the height H1 of the pouch case 31 in the corresponding section, and determine a maximum value among the heights of the folding part 34 measured in each section as the height H2 of the folding part 34 in the corresponding section.

The detection apparatus 100 may output the height H1 of the pouch case 31 and the height H2 of the folding part 34 by illustrating them as a graph. For example, when the measurement of the height of the pouch case 31 and the height of the folding part 34 is completed, as shown in FIGS. 5 and 6, the detection apparatus 100 may display the heights of the pouch case 31 measured in each section as a first graph 501, and display the heights of the folding part 34 as a second graph 502. As shown in FIG. 5, when there is no section where the height H2 of the folding part 34 is higher than the height H1 of the pouch case 31, the detection apparatus 100 may determine that it is a normal state (i.e., a state without a folding fault). On the other hand, as shown in FIG. 6, if a section where the height H2 of the folding part 34 is higher than the height H1 of the pouch case 31 exists at least partially, the detection apparatus 100 may determine that the folding fault has occurred. As the detection apparatus 100 according to the present disclosure expresses the measured height H1 of the pouch case 31 and the height H2 of the folding part 34 as the graph, a user (or manager) may easily grasp whether a folding fault occurs and a section where the folding fault has occurred.

Meanwhile, although the secondary battery 30 is illustrated and described as including one folding part 34 in the above, the secondary battery 30 may include two or more folding parts.

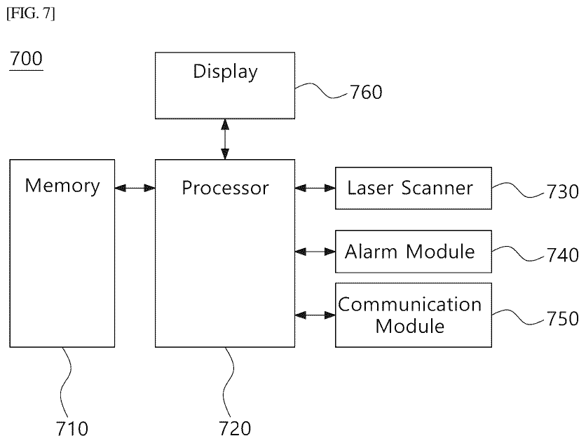

FIG. 7 is a block diagram illustrating a configuration of an apparatus for detecting a folding fault of a secondary battery according to an embodiment of the present disclosure.

Referring to FIG. 7, an apparatus 700 for detecting a folding fault of a secondary battery (hereinafter, “a detection apparatus”) according to an embodiment of the present disclosure may be the detection apparatus 100 of FIG. 1. However, the detection apparatus 700 may be operated in conjunction with the transfer apparatus 200 as in FIG. 1, or may be operated separately.

According to an embodiment, the detection apparatus 700 may include a memory 710, a processor 720, a laser scanner 730, an alarm module 740, a communication module 750, and a display 760.

The memory 710 may store a program for controlling an operation of the detection apparatus 700 and/or information (e.g., a reference value, the region of interest, the number of sections, the graph, etc.) necessary to control the operation of the detection apparatus 700.

The processor 720 may control the overall operation of the detection apparatus 700. For example, the processor 720 may receive commands or instructions from the memory 710, and control each component according to the received commands or instructions to perform various functions. The processor 720 may be consist of a central processing unit (CPU), a micro control unit (MCU), a microprocessor unit (MPU), etc.

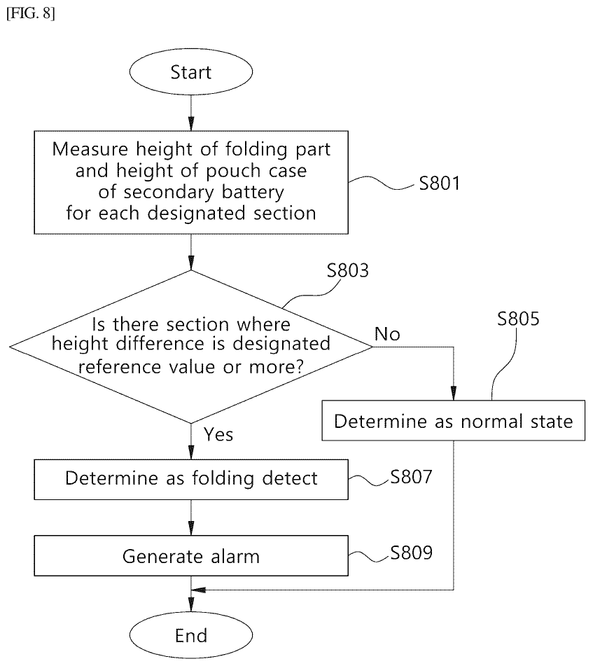

According to an embodiment, the processor 720 may control the configurations (e.g., the laser scanner 730, the alarm module 740, and the communication module 750) of the detection apparatus 700 to check whether there is a folding fault of the secondary battery 30, and to generate an alarm to notify an occurrence of the folding fault, which will be described in detail below with reference to FIG. 8.

The laser scanner 730 may measure the height of the folding part and the height of the pouch case of the secondary battery. For example, the laser scanner 730 may emit a laser in a designated range according to a designated scan rate and receive a reflected laser to measure the height of the folding part and the height of the pouch case.

The alarm module 740 may generate an alarm in the designated manner when a designated condition is satisfied. For example, the alarm module 740 may generate an alarm when a folding fault is detected. The alarm module 740 may generate at least one of a visual alarm (e.g., lighting a light emitting diode (LED), displaying an icon, displaying a pop-up window, etc.), an audible alarm (e.g., outputting a sound effect), and a tactile alarm (e.g., generating a vibration). To this end, the alarm module 740 may include at least one of a light emitting diode, a display, a speaker, and a vibration motor.

The communication module 750 may communicate with an external device (e.g., the transfer apparatus 200 of FIG. 1, a portable terminal (e.g., a smart phone) of the manager, etc.) through wired communication or wireless communication. For example, the communication module 750 may receive an inspection request for a folding fault from the transfer apparatus 200. In addition, the communication module 750 may notify the transfer apparatus 200 of the completion of the inspection when the folding fault inspection is completed. The transfer apparatus 200 that has been notified of the completion of the inspection may transfer the secondary battery on which the inspection has been completed to a location where the next process will be performed. As another example, the communication module 750 may transmit an alarm to notify an occurrence of a folding fault to a designated external device (e.g., the smart phone of the manager). As another example, the communication module 750 may transmit the graph illustrating the height of the folding part and the height of the pouch case to a designated external display device.

The display 760 may perform a function of displaying various screens (e.g., images). According to some embodiments, the display 760 may include a touch panel for performing an input function. For example, the display 760 may output the height of the folding part and the height of the pouch case as the graph.

Meanwhile, the detection apparatus 700 may not include some of the above-described configurations, or may further include other configurations. For example, the detection apparatus 700 may not include the alarm module 740, the communication module 750, and/or the display 760. As another example, the detection apparatus 700 may further include an input module for receiving an input (e.g., an operation command) of the user. Alternatively, some of the configurations of the detection apparatus 700 may be formed as separate external devices. For example, the laser scanner 730 and/or the display 760 of the detection apparatus 700 may be formed as separate external devices.

FIG. 8 is a flowchart for describing procedures of a method for detecting a folding fault of a secondary battery according to an embodiment of the present disclosure.

Referring to FIG. 8, the method for detecting a folding fault of a secondary battery according to an embodiment of the present disclosure may include a step (S801) of measuring a height of a folding part and a height of a pouch case of the secondary battery. For example, a detection apparatus (e.g., the processor 720) may measure a height of the folding part and a height of the pouch case of the secondary battery while being transferred by a carrier (e.g., the carrier 220) of the transfer apparatus using a laser scanner (e.g., the laser scanner 730). According to an embodiment, the detection apparatus may measure the height of the folding part and the height of the pouch case while the carrier on which the secondary battery is placed passes through the lower end of the laser scanner at a designated speed along the rail of the transfer apparatus. Meanwhile, a partial region of the measurement range of the laser scanner may be set as a region of interest, and the detection apparatus may measure the height of the pouch case through a first region of interest among the set regions of interest, and measure the height of the folding part through a second region of interest among the regions of interest. The detection apparatus may start the measurement when the secondary battery is detected in the region of interest, and may end the measurement when the secondary battery is not detected from the region of interest. The detection apparatus may measure the height of the folding part and the height of the pouch case for each designated section in the longitudinal direction of the secondary battery. The detection apparatus may determine a maximum value among the heights of the folding part measured in each section as the height of the folding part in the corresponding section, and determine a maximum value among the heights of the pouch case measured in each section as the height of the pouch case in the corresponding section. The detection apparatus may output the determined heights of the folding part and the determined heights of the pouch case as the graph.

The method may include a step (S803) of checking whether a height difference is a designated reference value or more. For example, the detection apparatus (e.g., the processor 720) may check whether there is a section where the height of the folding part is greater than the height of the pouch case, provided that the height difference is the designated reference value or more among the measurement sections.

As a result of the check in the step S803, if there is no section where the height difference is the designated reference value or more, the method may proceed to a step (S805) of determining that it is in a normal state. On the other hand, as a result of the check in the step S803, if there is a section where the height difference is the designated reference value or more, the method may proceed to a step (S807) of determining that the folding fault has occurred.

The method may include a step (S809) of generating an alarm. For example, the detection apparatus may control the alarm module 740 to generate an alarm so as to notify an occurrence of the folding fault in the designated manner (for example, a visual alarm (e.g., lighting a light emitting diode (LED), displaying an icon, displaying a pop-up window, etc.), an audible alarm (e.g., outputting a sound effect), and/or a tactile alarm (e.g., generating a vibration)).

Meanwhile, although not shown in FIG. 8, the method may further include a step of transmitting an alarm to notify an occurrence of the folding fault to a designated external device (e.g., the smart phone of the manager) through a communication module (e.g., the communication module 750).

The contents described above are merely an example of applying the principle of the present disclosure, and other configurations may be further included without departing from the scope of the present invention. For example, at least some of the various embodiments of the present disclosure described above may be combined.

What is claimed is:

1. A method for detecting a folding fault of a secondary battery, the method comprising:
measuring a height of a folding part and a height of a pouch case of the secondary battery being transferred by a transfer apparatus for each designated section using a laser scanner;
checking whether there is a section where the height of the folding part is greater than the height of the pouch case, provided that a height difference therebetween is a designated reference value or more; and
if there is a section where the height difference is the designated reference value or more, determining that the folding fault has occurred.

2. The method according to claim 1, wherein the laser scanner is fixedly disposed on an upper side of the rail of the transfer apparatus, and
the measuring step is performed while the carrier on which the secondary battery is placed moves to pass a lower end of the laser scanner along the rail at a designated speed.

3. The method according to claim 1, wherein a partial region of a measurement range of the laser scanner is set as a region of interest, and
the measuring step comprises measuring the height of the pouch case through a first region of interest among the regions of interest, and measuring the height of the folding part through a second region of interest among the regions of interest.

4. The method according to claim 3, wherein the measuring step comprises starting the measurement when the secondary battery is detected in the region of interest, and ending the measurement when the secondary battery is not detected from the region of interest.

5. The method according to claim 1, wherein the measuring step comprises measuring the height of the folding part and the height of the pouch case for each designated section in a longitudinal direction of the secondary battery.

6. The method according to claim 5, wherein the measuring step comprises determining a maximum value among the heights of the folding part measured in each section as the height of the folding part in the corresponding section, and determining a maximum value among the heights of the pouch case measured in each section as the height of the pouch case in the corresponding section.

7. The method according to claim 6, further comprising outputting the determined heights of the folding part and the determined heights of the pouch case by illustrating them as a graph.

8. The method according to claim 1, further comprising generating an alarm in a designated manner when it is determined that the folding fault has occurred.

9. An apparatus for detecting a folding fault of a secondary battery, the apparatus comprising:
a laser scanner configured to emit a laser in a designated range according to a designated scan rate and receive a reflected laser; and
a processor configured to control the laser scanner to measure a height of a folding part and a height of a pouch case of the secondary battery being transferred by a transfer apparatus for each designated section, check whether there is a section where the height of the folding part measured through the laser scanner is greater than the height of the pouch case, provided that a height difference therebetween is a designated reference value or more, and if there is section where the height difference is the designated reference value or more, determine that the folding fault has occurred.

10. The apparatus according to claim 9, wherein the laser scanner is fixedly disposed on an upper side of the rail of the transfer apparatus, and
the processor measures the height of the folding part and the height of the pouch case while the carrier on which the secondary battery is placed moves to pass a lower end of the laser scanner along the rail at a designated speed.

11. The apparatus according to claim 9, wherein a partial region of a measurement range of the laser scanner is set as a region of interest, and
the processor measures the height of the pouch case through a first region of interest among the regions of interest, and measuring the height of the folding part through a second region of interest among the regions of interest.

12. The apparatus according to claim 11, wherein the processor starts the measurement when the secondary battery is detected in the region of interest, and ends the measurement when the secondary battery is not detected from the region of interest.

13. The apparatus according to claim 9, wherein the processor measures the height of the folding part and the height of the pouch case for each designated section in a longitudinal direction of the secondary battery.

14. The apparatus according to claim 11, wherein the processor determines a maximum value among the heights of the folding part measured in each section as the height of the folding part in the corresponding section, and determines a maximum value among the heights of the pouch case measured in each section as the height of the pouch case in the corresponding section.

15. The apparatus according to claim 14, further comprising a display configured to output the determined heights of the folding part and the determined heights of the pouch case by illustrating them as a graph.

16. The apparatus according to claim 9, further comprising an alarm module configured to generate an alarm in a designated manner when the folding fault occurs.

17. A system for detecting a folding fault of a secondary battery, the system comprising:
a transfer apparatus configured to transfer the secondary battery;
a laser scanner fixedly installed on one side of the transfer apparatus, and configured to measure a height of a folding part and a height of a pouch case of the secondary battery while being transferred through the transfer apparatus for each designated section; and
a detection apparatus configured to detect whether a folding fault occurs based on the height of the folding part and the height of the pouch case measured by the laser scanner.
